(19) United States
(12) Patent Application Publication
(10) Pub. No.: US 2017/0166317 A1
(43) Pub. Date: Jun. 15, 2017

(54) Support pylon for a turbomachine, provided with a thermal protection element

(71) Applicant: Airbus Operations SAS, Toulouse (FR)

(72) Inventors: Yann Queau, RAMONVILLE SAINT AGNE (FR); Camille Chaper, TOULOUSE (FR)

(21) Appl. No.: 15/375,474

(22) Filed: Dec. 12, 2016

(30) Foreign Application Priority Data
Dec. 11, 2015 (FR) 1562179

(51) Int. Cl. B64D 27/26; B64D 27/18

(52) U.S. Cl. CPC B64D 27/26; B64D 27/18

(57) ABSTRACT

A support pylon for an aircraft turbomachine having the overall shape of a box defined by lateral walls, at least one of the lateral walls having an external surface comprising a thermal protection element, the element being mobile as a result of a rise in temperature between a first, retracted position, in which the element is aligned with the external surface and a second, deployed position, in which the element protrudes from the external surface. The element provides thermal protection which is able to be automatically deployed-retracted in order to protect the parts of the pylon against thermal heating. In its retracted position, the thermal protection element generates low drag.

### CROSS-REFERENCES TO RELATED APPLICATIONS

This application claims the benefit of the French patent application No. 1562179 filed on Dec. 11, 2015, the entire disclosures of which are incorporated herein by way of reference.

### BACKGROUND OF THE INVENTION

The present invention relates to a support pylon for a turbomachine comprising a thermal protection element which is arranged on an external surface of a lateral wall of the pylon so as to protect the pylon against thermal heating.

It is disclosed in the document U.S. Pat. No. 7,988,092 to install a vortex generating device on an external surface of a lateral wall of the pylon. Such a vortex generating device provides additional thermal protection to the pylon by generating cold air vortices when it receives an incident airflow (air outside the aircraft). The vortices escape downstream of the wing tip and pass through the hot airflows which flow along the pylon toward the wing, resulting in the diversion of the path of the hot airflows and the cooling thereof.

### SUMMARY OF THE INVENTION

An object of the present invention is to improve the elements for the additional thermal protection of a pylon. To this end, the invention relates to a support pylon for an aircraft turbomachine having the overall shape of a box defined by lateral walls, at least one of the lateral walls having an external surface, a thermal protection element being fixed thereto, the element being mobile as a result of a rise in temperature between a first position, called the retracted position, in which the element is aligned with the external surface and a second position, called the deployed position, in which the element protrudes from the external surface.

The invention provides thermal protection which is able to be automatically deployed-retracted but only when this is necessary in order to protect the parts of the pylon against thermal heating. In its retracted position, the thermal protection element 100 generates low drag.

### BRIEF DESCRIPTION OF THE DRAWINGS

Further advantages and features of the invention will be disclosed from the following detailed non-limiting description.

This description is made with reference to the accompanying drawings, in which:

FIG. 1 is a schematic view of a wing, an engine assembly comprising a pylon according to the invention being attached below the wing and a turbomachine being attached to the pylon, the pylon comprising a thermal protection element fixed to a lateral wall of the pylon to protect the pylon from hot gases ejected by the turbomachine;

FIG. 2 is a schematic view of the pylon of FIG. 1, in the direction indicated by the arrow A, and illustrating the thermal protection element which is able to be deployed into a retracted position according to a first embodiment of the invention;

FIG. 3 is a view similar to FIG. 2 illustrating the thermal protection element in a deployed position;

FIG. 4 is a schematic view of the pylon of FIG. 1, in the direction indicated by the arrow A, and illustrating the thermal protection element which is able to be deployed into a deployed position according to a second embodiment of the invention.

### DETAILED DESCRIPTION OF THE PREFERRED EMBODIMENTS

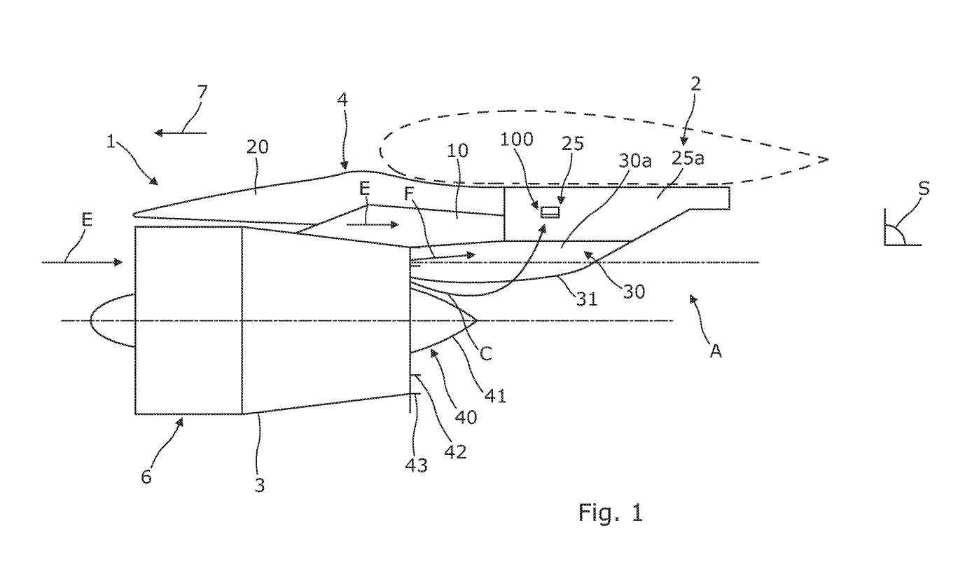

An engine assembly 1 fixed below a wing 2 of an aircraft has been shown with reference to FIG. 1. The engine assembly comprises a support pylon 4 according to the invention in addition to a turbomachine 6, for example a turbojet engine, which is attached below the wing 2 via the pylon 4 and which is surrounded by a nacelle 3.

The pylon 4 has the overall shape of a box defined by lateral walls. It comprises, in the known mariner, a rigid structure, also called the primary structure 10, permitting the turbomachine 6 to be supported via the known means. Moreover, the pylon 4 comprises secondary structures forming the fairing of the primary structure 10. In particular, the secondary structures include a front aerodynamic structure 20, a rear aerodynamic structure 25, and a rear aerodynamic fairing 30 (or APF aft pylon fairing) located below the rear aerodynamic structure.

Each secondary structure has the shape of an open box defined by left and right lateral walls which form the lateral walls, respectively the left and right lateral walls, of the pylon. Thus, the rear aerodynamic structure 25 has a left lateral wall 25a and a right lateral wall 25b (only the left lateral wall is shown in FIG. 1) and the rear aerodynamic fairing 30 has a left lateral wall 30a and a right lateral wall 30b (only the left lateral wall is shown in FIG. 1). Each lateral wall has an external surface aligned with the air. The rear aerodynamic fairing 30 also comprises a base 31 which forms the lower wall of the pylon.

The terms “front” and “rear” are to be considered relative to a forward direction of the aircraft which is present as a result of the thrust exerted by the turbojet engine 6, this direction being shown schematically by the arrow 7. The terms “left” and “right” are to be considered relative to the median plane S of the pylon 4 separating the pylon into a left part and a right part which are substantially symmetrical relative to the plane.

The turbomachine 6 of the dual-flow type comprises an ejection part which is composed of, for example, an ejection cone 41 and two concentric nozzles 42, 43 surrounding the ejection cone. During operation, the turbomachine ejects via the ejection part, a cold gas flow F (at a temperature of 100 to 150° C.) called the secondary airflow and a hot gas flow C called the primary airflow (at a temperature of 180 to 300° C.). The primary airflow C comes into contact with the base 31 of the rear aerodynamic fairing while the secondary airflow F comes into contact with the external surfaces of the left lateral wall 30a and right lateral wall 30b of the rear aerodynamic fairing 30.

The primary airflow C at the outlet of the turbomachine tends to rise toward the wing 2 and forms a boundary layer of hot air moving on the external surfaces of the lateral walls 30a-b of the rear aerodynamic fairing and the lateral walls 25a-b of the rear aerodynamic structure. The boundary layer is defined as the depth of the hot airflow (primary airflow C) between the external surfaces of the lateral walls 25a-b, 30a-b of the pylon and the external cold airflow E (temperature <100° C.) at the boundary layer. The external cold air E at the boundary layer is a mixture between the external air at the boundary layer and the secondary airflow ejected by the turbomachine.

According to the invention, the engine assembly 1 comprises at least one thermal protection element 100 which is arranged on an external surface of a lateral wall of the pylon 25a-b, 30a-b and which is mobile as a result of a rise in temperature between a first position, called the retracted position, in which the element is aligned with the external surface and a second position, called the deployed position, in which the element protrudes from the external surface.

It will be noted in FIG. 1 that the protection element 100 is fixed to the external surface of the left lateral wall 25a of the rear aerodynamic structure 25.

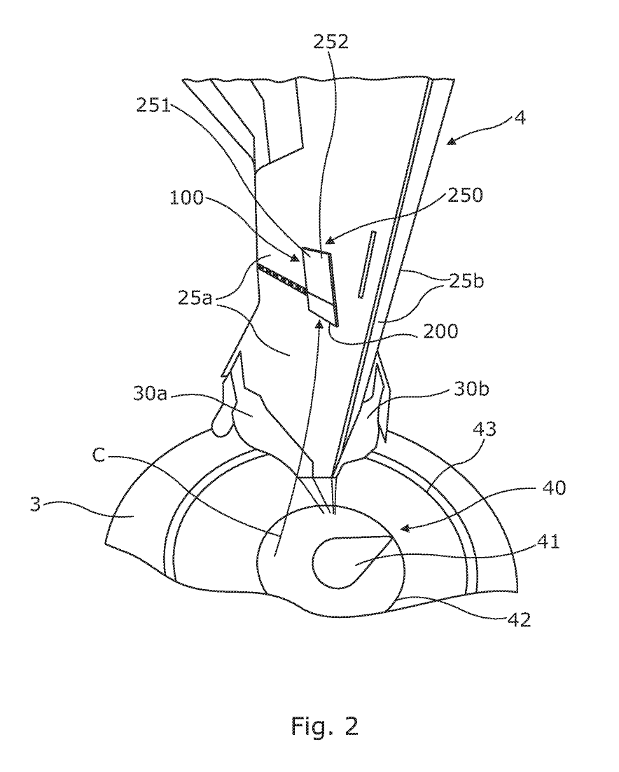

With reference to FIG. 2, the thermal protection element 100 comprises a base portion 200 which is fixed (for example by screwing, welding or riveting) to an external surface of an external lateral wall of the pylon and a substantially planar strip 250 of parallelepipedal shape which is fixed over its width to the base portion 200 (for example by screwing, welding or riveting).

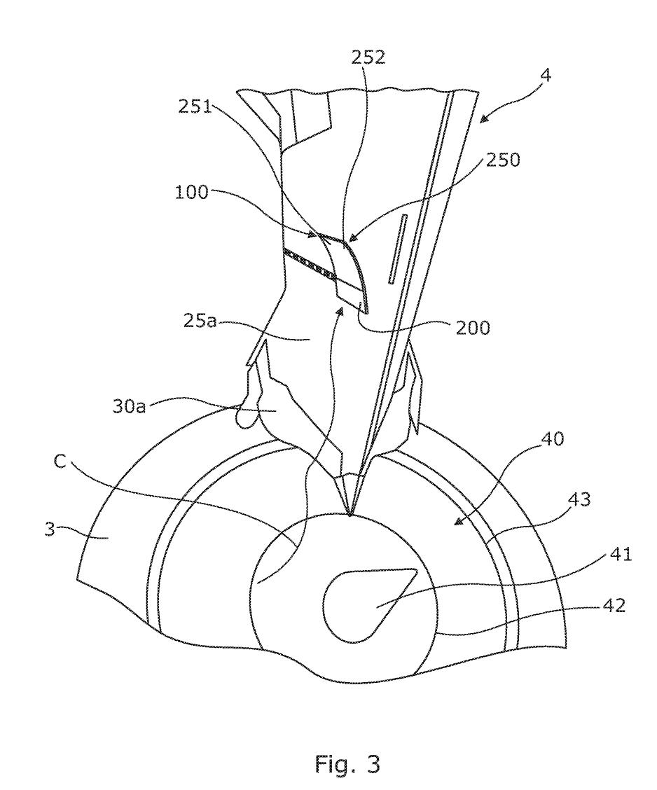

In a first embodiment illustrated with reference to FIGS. 2 and 3, the strip 250 is bimetallic and comprises two sheets 251, 252 joined in the thickness of the strip where each sheet 251, 252 is produced from a different metal and has a coefficient of thermal expansion which is different from the metal in which the other sheet is produced. The sheet 252 comprising the metal which has the greatest coefficient of thermal expansion is located on the side of the pylon (i.e., the internal side of the thermal protection element 100), and the sheet 251 comprising the metal which has the lowest coefficient is located on the external side of the thermal protection element 100.

The strip 250 comprises, for example, sheets produced in pairs of metals selected from one of the following combinations: titanium and an alloy of Cr—Ni—Fe (chrome, nickel-iron) or nickel and iron or copper and an alloy of aluminum or copper and zinc.

The features of the strip 250 (material, thickness of materials, width of sheets, length of the strip, etc.) are selected such that the strip has a planar shape in the so-called retracted position of the mobile element 100 and a bent shape in the so-called deployed position of the element. The strip 250 is bent continuously in a direction moving away from the pylon when the temperature increases and continuously straightened in an opposing direction when the temperature then reduces. Preferably, the strip 250 has features which are selected such that the strip starts to bend in a linear manner at a temperature value (called the temperature threshold) on the order of 150° C. and is bent to the maximum extent at a temperature of greater than 200° C.

So that the shape of the protection element 100 changes with the temperature of the hot air of the boundary layer, the base portion 200 is placed along the path of the primary airflow C forming the boundary layer of hot air rising to the wing 2, this path being determined empirically.

In the so-called retracted position of the thermal protection element 100, the strip 250 is substantially parallel, or even in contact, with the external surface of the lateral wall of the pylon 4, the base portion 200 being fixed thereto (FIG. 3). The thermal protection element 100 is then aligned with the surface.

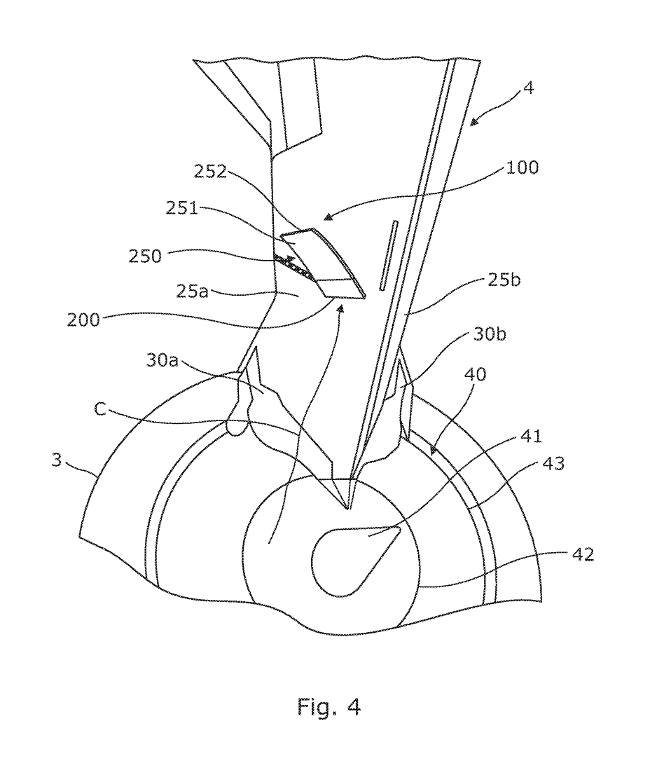

In contrast, between the so-called retracted position and the so-called deployed position of the thermal protection element 100, the strip forms a fin protruding from the surface (FIG. 4). It should be noted that the base portion 200 is fixed to the external surface of the lateral wall of the pylon 4 such that the strip has an angle of attack which is substantially zero relative to the direction of the external cold airflow E. In the so-called deployed position of the thermal protection element 100, the strip 250 is preferably substantially perpendicular to the external surface of the lateral wall of the pylon 4, the base portion 200 being fixed thereto.

The invention thus provides thermal protection which is able to be automatically deployed-retracted between a first position and a second position in order to protect the parts of the pylon against thermal heating. In its retracted position, the thermal protection element 100 generates low drag.

Preferably, the strip 250 is fixed above the base portion 200 such that when the strip is bent, the thermal protection element 100 separates the boundary layer passing via the strip from the external surface and, in addition, causes the hot air of the layer to be drawn toward the element 100. The hot air C of the boundary layer separated from the external surface of the pylon is mixed with the external cold airflow E at the boundary layer and is thus cooled.

When the temperature of the boundary layer is reduced, the strip is straightened and produces less drag.

By way of example, the strip may be produced from a sheet of copper and a sheet of aluminum alloy may have a length of 15 cm and a width of 7 cm with a thickness of 4 mm The sheet of copper may have a width of 2 mm while the sheet of aluminum alloy may have a width of 2 mm. Such a strip is bent to a maximum extent at a temperature of greater than 200° C., while the strip is flattened against the lateral wall of the pylon 4 at a temperature of less than 150° C.

Preferably, and in order to increase the thermal protection of the pylon 4, the pylon according to the invention comprises at least one pair of protection elements 100 arranged symmetrically on either side of the median plane S of the pylon 4.

Moreover, the strip 20 is advantageously profiled in order to reduce the drag caused thereby.

In a second embodiment of the invention illustrated with reference to FIG. 4, the base portion 200 is fixed to an external surface of a lateral wall of the pylon, in this case the left lateral wall 25a of the rear aerodynamic structure 25 in the example illustrated in FIG. 4, such that the plane (plane passing through its chord when the strip is profiled) of the strip 250 produces an angle of attack in the order of 10 to 20° (or −10 to −20°) relative to the direction of the external cold airflow E.

The operation of the thermal protection element 100 according to this embodiment is identical to that disclosed above.

So that the shape of the protection element 100 changes with the temperature of the hot air of the boundary layer, the base portion 200 is placed along the path of the primary airflow C forming the boundary layer of hot air rising toward the wing 2, this path being determined empirically.

Apart from the advantages of such a thermal protection element cited above, when the strip 250 is bent, the thermal protection element 100 according to this embodiment permits vortices to be generated in the external flow E at the boundary layer incident to the strip. The vortices of cold air escape downstream of the strip 250 and pass through the hot airflow C contained in the boundary layer: by passing through this hot boundary layer, each vortex diverts the hot boundary layer and mixes it with the external cold airflow E at the boundary layer. The pylon 4 is thus protected against thermal heating.

As a variant of the two embodiments disclosed above, the strip 250 is not a bimetallic strip but a strip produced from a shape-memory material which bends abruptly when the temperature increases beyond a certain temperature value, called the threshold value, or straightens abruptly to readopt its initial position when the temperature then falls below the threshold value. The strip is produced, for example, from an alloy of copper-zinc-aluminum or copper-zinc-tin or copper-zinc-silicon and the threshold value is in the order of 160°.

The invention may be applied to any pylon, in particular of the type of those having a single component comprising the secondary structure which forms the fairing for the primary structure of the pylon. Such a pylon comprises a single external lateral surface on each side of the median plane S of the pylon.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A support pylon for an aircraft turbomachine having the overall shape of a box defined by lateral walls, at least one of the lateral walls having an external surface comprising a thermal protection element, wherein said thermal protection element is mobile as a result of a rise in temperature between a first, retracted position, in which said thermal protection element is aligned with the external surface and a second, deployed position, in which said thermal protection element protrudes from the external surface.

2. The support pylon according to claim 1, wherein the mobile element comprises a base portion fixed to said external surface and a strip fixed to the base portion, the strip having a planar shape in the retracted position and a bent shape in the deployed position.

3. The pylon according to claim 1, wherein the strip is bimetallic and comprises two metal sheets which are joined in the direction of thickness of the strip, where each sheet is produced from a metal which is different from the metal in which the other sheet is produced, the two metals having different coefficients of thermal expansion.

4. The pylon according to claim 3, wherein the two sheets are produced in pairs of metals selected from one of the following combinations:
titanium and an alloy of chrome-nickel-iron,
nickel and iron,
copper and aluminum, or
copper and zinc.

5. The pylon according to claim 1, wherein the strip is produced from a shape-memory material.

6. The pylon according to claim 5, wherein the material of the strip is selected from one of the following materials:
copper-zinc-aluminum,
copper-zinc-tin, or
copper-zinc-silicon.

7. The pylon according to claim 2, wherein the strip reaches the deployed position at a temperature which is greater than 200° C.

8. The pylon according to claim 2, wherein, in the deployed position, the strip is substantially perpendicular to the external surface of the lateral wall, the base being fixed thereto.
